(19) United States
(12) Patent Application Publication
(10) Pub. No.: US 2017/0145154 A1
(43) Pub. Date: May 25, 2017

(54) MODIFIED COPOLYESTER COMPOSITION

(71) Applicant: Far Eastern New Century Corporation, Taipei City (TW)

(72) Inventors: Der-Ren HWANG, Taipei City (TW); Chia-Huei CHEN, Taipei City (TW)

(73) Assignee: Far Eastern New Century Corporation, Taipei City (TW)

(21) Appl. No.: 15/155,177

(22) Filed: May 16, 2016

(30) Foreign Application Priority Data
Nov. 24, 2015 (TW) 104138970

(51) Int. Cl. C08G 63/672

(52) U.S. Cl. CPC C08G 63/672

(57) ABSTRACT

A modified copolyester composition includes a copolymer obtained by subjecting a stoichiometric mixture of an aromatic dicarboxylic acid-based component and a diol component to a polycondensation reaction, wherein the diol component includes a major amount of a C₂-C₄ aliphatic diol and a minor amount of an aromatic diol compound represented by Formula (I) defined herein, and wherein the dicarboxylic acid-based component is selected from the group consisting of an aromatic dicarboxylic acid, an aromatic dicarboxylic dialkyl ester, and a combination thereof.

### CROSS-REFERENCE TO RELATED APPLICATION

This application claims priority of Taiwanese Application No. 104138970, filed on Nov. 24, 2015.

### FIELD

The disclosure relates to a modified copolyester composition, and more particularly to a modified copolyester composition having a relatively high glass transition temperature.

### BACKGROUND

Polyesters are conventionally formed by subjecting polyol components and polyacid components to polycondensation, and common examples thereof include polyethylene terephthalate (PET), polybutylene terephthalate (PBT), polytrimethylene terephthalate (PTT), poly(1,4-cyclohexylene dimethylene terephthalate (PCT), poly(ethylene 2,6-naphthalate) (PEN), and the like.

Chinese Patent Publication No. 103588926A discloses a modified polyester composition formed by subjecting a reaction mixture to polymerization. The reaction mixture includes a diol component, a diacid-based component, and a modifier represented by Formula (A):

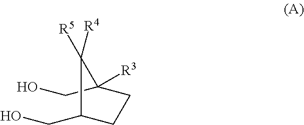

wherein R³, R⁴, and R⁵ independently represent hydrogen or a methyl group, and at least one of R³, R⁴, and R⁵ is a methyl group.

With the inclusion of the modifier of formula (A), the modified polyester composition of the aforesaid Chinese patent publication exhibits an increased glass transition temperature compared to conventional PET. However, in the aforesaid Chinese patent publication, the modified polyester composition of Example 1 which includes 3 mole % of the modifier of Formula (A) has a glass transition temperature of 82° C., an increase of only 4.7° C. compared to the modified polyester composition of Comparative Example 1, which is free of the modifier and has a glass transition temperature of 77.3° C. Furthermore, the modified polyester composition of Example 2 which includes 10 mole % of the modifier of Formula (I) has a glass transition temperature of 84° C., an increase of only 6.7 t compared to that of Comparative Example 1.

It is evident from the aforesaid that the effect of the modifier of Formula (A) of the Chinese patent publication in increasing the glass transition temperature is not satisfactory.

### SUMMARY

Therefore, an object of the disclosure is to provide a modified copolyester composition having a relatively high glass transition temperature.

According to the disclosure, there is provided a modified copolyester composition which includes a copolymer obtained by subjecting a stoichiometric mixture of an aromatic dicarboxylic acid-based component and a diol component to a polycondensation reaction. The diol component includes a major amount of a C₂-C₄ aliphatic diol and a minor amount of an aromatic diol compound represented by Formula (I),

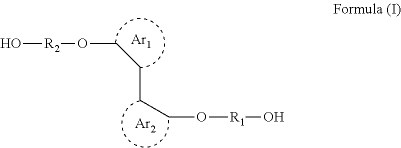

wherein

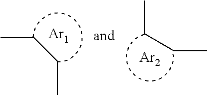

independently represent an ortho-arylene group, and

R₁ and R₂ independently represent a C₂-C₄ alkylene group.

The dicarboxylic acid-based component is selected from the group consisting of an aromatic dicarboxylic acid, an aromatic dicarboxylic dialkyl ester, and a combination thereof.

### DETAILED DESCRIPTION

A modified copolyester composition of the disclosure includes a copolymer obtained by subjecting a stoichiometric mixture of an aromatic dicarboxylic acid-based component and a diol component to a polycondensation reaction. The diol component includes a major amount of a C₂-C₄ aliphatic diol and a minor amount of an aromatic diol compound represented by Formula (I),

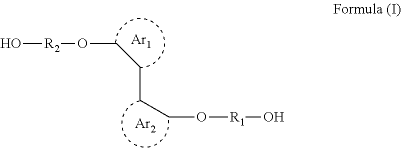

wherein

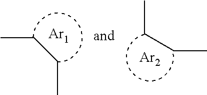

independently represent an ortho-arylene group, and R₁ and R₂ independently represent a C₂-C₄ alkylene group.

In certain embodiments, the aromatic diol compound is represented by

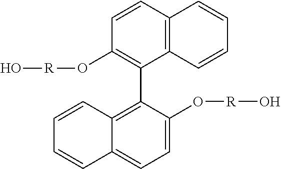

wherein each R is independently a C₂-C₄ alkylene group.

In certain embodiments, the aromatic diol compound is

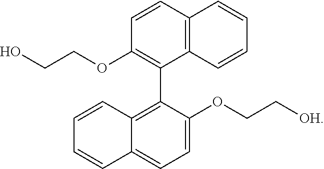 [SMILES: OCCOc1ccc2ccccc2c1-c1c(OCCO)ccc2ccccc12]

The dicarboxylic acid-based component is selected from the group consisting of an aromatic dicarboxylic acid, an aromatic dicarboxylic dialkyl ester, and a combination thereof.

In certain embodiments, the polycondensation reaction is conducted in the presence of a first catalyst. Examples of the first catalyst include, but are not limited to, antimony-containing compounds (e.g., antimony (III) oxide (Sb₂O₃)), germanium-containing compounds, tin-containing compounds, titanium-containing compounds, gallium-containing compounds, and aluminum-containing compounds. These compounds may be used alone or in combination. The amount of the first catalyst used in the polycondensation reaction may be suitably adjusted according to specific requirements, such as the extent of the polycondensation reaction. During the polycondensation reaction, the carboxylic acid group (—COOH) of the aromatic dicarboxylic acid and the hydroxyl group of the diol component undergo an esterification reaction, or the carboxylic alkyl ester group of the aromatic dicarboxylic dialkyl ester and the hydroxyl group of the diol component undergo a transesterification reaction, followed by a polymerization reaction. There is no specific limitation to the reaction temperature of the esterification reaction or the transesterification reaction as long as the esterification reaction or the transesterification reaction can be carried out. In certain embodiments, the temperature of the esterification reaction or the transesterification reaction ranges from 160 to 250 t. It should be noted that the first catalyst may be added when the conversion rate of the esterification reaction or the transesterification reaction is greater than 80%. There is no specific limitation to the temperature and the pressure of the polymerization reaction as long as the reaction can be carried out. In certain embodiments, the temperature of the polymerization reaction ranges from 200 to 300° C., and in certain embodiments, the temperature of the polymerization reaction ranges from 280 to 300° C. In certain embodiments, the pressure of the polymerization reaction is under 3 torr.

There is no specific limitation to the aromatic dicarboxylic acid. In certain embodiments, the aromatic dicarboxylic acid is a C₈-C₁₂ aromatic dicarboxylic acid. Examples of the C₈-C₁₂ aromatic dicarboxylic acid include, but are not limited to, terephthalic acid (TPA), phthalic acid, isophthalic acid (IPA), and 2,6-naphthalic acid, which can be used alone or in combination.

There is no specific limitation to the aromatic dicarboxylic dialkyl ester. In certain embodiments, the aromatic dicarboxylic dialkyl ester is a C₁₀-C₁₄ aromatic dicarboxylic dialkyl ester. Examples of the C₁₀-C₁₄ aromatic dicarboxylic dialkyl ester include, but are not limited to, terephthalic acid dialkyl ester, phthalic acid dialkyl ester, isophthalic acid dialkyl ester, 2,6-naphthalic acid dialkyl ester, and biphenyl dicarboxylic acid dialkyl ester, which can be used alone or in combination.

Examples of the C₂-C₄ aliphatic diol include, but are not limited to, ethylene glycol (EG), 1,3-propanediol, 1,2-propanediol, 1,3-butanediol, 1,4-butanediol, and 2,3-butanediol, which can be used alone or in combination.

The aromatic diol compound represented by Formula (I) is obtained by subjecting a dihydric aromatic compound and a cyclic carbonate to a reaction.

There is no specific limitation to the cyclic carbonate. In certain embodiments, the cyclic carbonate is a C₃-C₅ cyclic carbonate. Examples of the C₃-C₅ cyclic carbonate include, but are not limited to, ethylene carbonate, 1,2-butylene carbonate, and propylene carbonate, which can be used alone or in combination. In certain embodiments, the C₃-C₅ cyclic carbonate is ethylene carbonate.

There is no specific limitation to the dihydric aromatic compound. In certain embodiments, the dihydric aromatic compound is 1,1′-bi-2-naphthol (BINOL).

The reaction for obtaining the aromatic diol compound represented by Formula (I) is conducted in the presence of a second catalyst. Examples of the second catalyst include, but are not limited to, sodium chloride, potassium iodide, potassium carbonate, potassium hydroxide, sodium hydroxide, and combinations thereof. The examples of the second catalyst may be used alone or in combination. There are no specific limitations regarding the reaction conditions, such as the amount ratio of the cyclic carbonate to the dihydric aromatic compound, the amount of the second catalyst, the reaction temperature, and the reaction time, as long as the reaction can be carried out. In certain embodiments, the amount ratio of the dihydric aromatic compound to the cyclic carbonate ranges from 2 to 4 equivalents. In certain embodiments, the amount of the second catalyst ranges from 0.005 to 0.5 mole based on 1 mole of the aromatic diol compound. In certain embodiments, the reaction temperature ranges from 90 to 180° C. In certain embodiments, the reaction time ranges from 4 to 18 hours.

In certain embodiments, a total amount of the C₂-C₄ aliphatic diol and the aromatic diol compound ranges from 1 mole to 1.5 moles based on 1 mole of the aromatic dicarboxylic acid-based component. In certain embodiments, the total amount of the C₂-C₄ aliphatic diol and the aromatic diol compound ranges from 1 mole to 1.25 moles based on 1 mole of the aromatic dicarboxylic acid-based component.

In certain embodiments, the minor amount of the aromatic diol compound ranges from 0.5 mole % to 10 mole % based on 100 mole % of a total of the C₂-C₄ aliphatic diol and the aromatic diol compound. When the minor amount of the aromatic diol compound is less than 0.5 mole %, the effect of increasing the glass transition temperature of the modified copolyester composition is not significant. It should be noted increasing the minor amount of the aromatic diol compound to be greater than 10 mole % would not further enhance the effect of increasing the glass transition temperature of the modified copolyester composition, and may merely unnecessarily increase manufacturing cost.

Examples of the disclosure will be described hereinafter. It is to be understood that these examples are exemplary and explanatory and should not be construed as a limitation to the disclosure.

### Examples

### <Chemicals>

1. 1,1′-bi-2-naphthol (BINOL): available from XiaoGan ShenYuan ChemPharm Co.

2. Ethylene carbonate: available from Oriental Union Chemical Co.

3. Toluene: available from Echo Chemical Co., industrial grade.

4. Ethyl acetate: available from Echo Chemical Co., industrial grade.

5. Sodium chloride: available from TAIYEN Co.

6. Ethylene glycol: available from Oriental Union Chemical Co.

7. Terephthalic acid: available from Oriental Petrochemical (Taiwan) Co.

8. Sb₂O₃: available from Aldrich Co., reagent grade, purity: 99.999%.

### <Preparation Example> Preparation of an Aromatic Diol Compound

BINOL, ethylene carbonate, and sodium chloride serving as a catalyst were mixed to form a reaction mixture. The molar ratio of BINOL to ethylene carbonate was 1:2.1, and the molar ratio of BINOL to sodium chloride was 1:0.1. The reaction mixture was subjected to a reaction at a temperature of 180° C. for 4 hours, followed by reducing the temperature and adding toluene and a large amount of ethyl acetate. A precipitate was obtained after standing at 25° C. A solid product was separated from the precipitate via suction filtration, and was identified as 2,2′-[1,1′-binaphthalene-2,2′-diylbis(oxy)] diethanol, which is represented by the following formula:

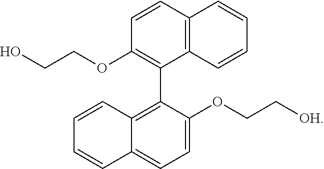 [SMILES: OCCOc1ccc2ccccc2c1-c1c(OCCO)ccc2ccccc12]

### <Examples> Preparation of Modified Copolyester Compositions

### Example 1 (E1)

2,2′-[1,1′-binaphthalene-2,2′-diylbis(oxy)] diethanol obtained in the preparation example was mixed uniformly with ethylene glycol at a molar ratio of 1:199 to forma reaction mixture, followed by mixing uniformly terephthalic acid with the reaction mixture at a molar ratio of 1:1.25. An esterification reaction was conducted at a temperature of 160 to 250° C. until the conversion rate of 85% was reached. Next, Sb₂O₃ (300 ppm) was added to conduct a polymerization reaction at a pressure of 3 torr and at a temperature from 250 to 280° C. for 3.5 hours to obtain a modified copolyester composition.

### Examples 2 and 3 (E2 and E3)

In Examples 2 and 3, the same steps as those in Example were performed to prepare modified copolyester compositions of Examples 2 and 3, respectively, except that the molar ratios of 2,2′-[1,1′-binaphthalene-2,2′-diylbis(oxy)] diethanol to ethylene glycol were 1:99 and 3:97 in Examples 2 and 3, respectively (see Table 1).

### Examples 4 and 5 (E4 and E5)

In Examples 4 and 5, the same steps as those in Example 1 were performed to prepare respectively modified copolyester compositions of Examples 4 and 5, except that the molar ratios of 2,2′-[1,1′-binaphthalene-2,2′-diylbis(oxy)] diethanol to ethylene glycol in Examples 4 and 5 were 1:19 and 1:9, respectively, and that the polymerization reaction times in Examples 4 and 5 were 2 and 3 hours, respectively (see Table 1).

### Comparative Example 1 (CE1)

The steps for preparing the copolyester composition in Comparative Example 1 were similar to those in Example 1, except that 2,2′-[1,1′-binaphthalene-2,2′-diylbis(oxy)] diethanol was not used in Comparative Example 1.

### <Analysis Test>

1. Measurement of glass transition temperature, melting point and crystallization temperature

The modified copolyester compositions of Examples 1 to 5 and the copolyester composition of Comparative Example 1 were respectively formed into copolyester pellets. The glass transition temperature (Tg), the melting point (Tm), and the crystallization temperature (Tcc) of the polyester pellets were measured using a differential scanning calorimeter (DSC) manufactured by TA instrument Co., USA, Model No.: DSC module 2910.

The measurement process was as follows: conducting a first temperature increasing step at an increasing rate of 10° C. per minute to reach a temperature of 300° C.; conducting a first temperature decreasing step at a decreasing rate of 10° C. per minute to reach a temperature of 30° C.; measuring the glass transition temperature and the melting point; conducting a second temperature increasing step at an increasing rate of 10° C. per minute and heating until the temperature was greater than the melting point; conducting a second temperature decreasing step at a decreasing rate of 10° C. per minute to reach a temperature of 30° C.; and measuring the crystallization temperature. The measurement results for Example 1 to 5 and Comparative example 1 are shown in Table 1.

TABLE 1

| | E1 | E2 | E3 | E4 | E5 | CE1 |
|---|---|---|---|---|---|---|
| Content of | 0.5 | 1 | 3 | 5 | 10 | 0 |
| aromatic diol | | | | | | |
| compound | | | | | | |
| (mole %)*¹ | | | | | | |
| Glass transition | 80.7 | 82.7 | 83.59 | 88.8 | 88.9 | 77.3 |
| temperature | | | | | | |
| (Tg) (° C.) | | | | | | |
| Crystallization | 192.1 | 186.0 | 158.9 | 173.1 | N.A. | 192.1 |
| temperature | | | | | | |
| (Tcc) (° C.) | | | | | | |
| Melting point | 218.1 | 247.1 | 238.51 | 237.6 | 215.6 | N.A.*² |
| (Tm) (° C.) | | | | | | |

*¹based on 100 mole % of a total of the aromatic diol compound and ethylene glycol.
*²“N.A.” indicates that the melting point or the crystallization temperature of the copolymer pellets was not detected.

It is evident from Table 1 that, with the inclusion of the aromatic diol compound represented by Formula (I), the modified copolyester compositions of Examples 1 to 5 exhibit higher glass transition temperatures than that of Comparative Example 1 in which the aromatic diol compound is not included.

In addition, compared to Chinese Patent Publication No. 103588926A, the modified copolyester composition of the disclosure exhibits a higher glass transition temperature than the polyester composition of Chinese Patent Publication No. 103588926A if the same amounts of the aromatic diol compound of the disclosure and the modifier of Chinese Patent Publication No. 103588926A are used.

Furthermore, in Examples 3 and 5, when the amounts of the aromatic diol compound are respectively 3 mole % and 10 mole % based on 100 mole % of a total of the aromatic diol compound and ethylene glycol, the glass transition temperatures of the modified copolyester composition are respectively increased to 83.59° C. and 88.9° C. The efficiency of increasing the glass transition temperature as achieved by the aromatic diol compound in the disclosure is better than that achieved in Chinese Patent Publication No. 103588926A.

To sum up, with the inclusion of the aromatic diol compound represented by Formula (I), the modified copolyester composition of the disclosure exhibits increased glass transition temperature, and the aromatic diol compound represented by Formula (I) has an increased efficiency of increasing the glass transition temperature.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A modified copolyester composition, comprising:
a copolymer obtained by subjecting a stoichiometric mixture of an aromatic dicarboxylic acid-based component and a diol component to a polycondensation reaction,
wherein said diol component includes a major amount of a C₂-C₄ aliphatic diol and a minor amount of an aromatic diol compound represented by Formula (I), 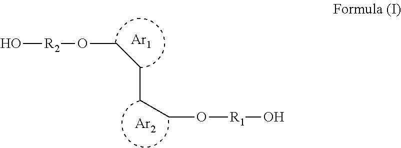
wherein 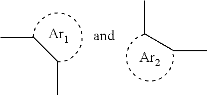
independently represent an ortho-arylene group, and
R₁ and R₂ independently represent a C₂-C₄ alkylene group,
and
wherein said aromatic dicarboxylic acid-based component is selected from the group consisting of an aromatic dicarboxylic acid, an aromatic dicarboxylic dialkyl ester, and a combination thereof.

2. The modified copolyester composition according to claim 1, wherein said aromatic diol compound represented by Formula (I) is obtained by subjecting a dihydric aromatic compound and a cyclic carbonate to a reaction.

3. The modified copolyester composition according to claim 2, wherein said cyclic carbonate is a C₃-C₅ cyclic carbonate.

4. The modified copolyester composition according to claim 3, wherein said cyclic carbonate is selected from the group consisting of ethylene carbonate, propylene carbonate, 1,2-butylene carbonate, and combinations thereof.

5. The modified copolyester composition according to claim 2, wherein said dihydric aromatic compound is 1,1′-bi-2-naphthol.

6. The modified copolyester composition according to claim 1, wherein said aromatic diol compound is represented by 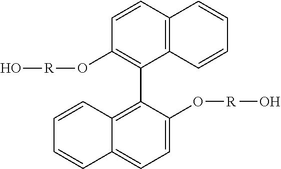
wherein each R is independently a C₂-C₄ alkylene group.

7. The modified copolyester composition according to claim 6, wherein said aromatic diol compound is

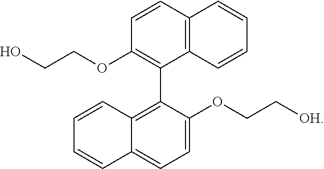 [SMILES: OCCOc1ccc2ccccc2c1-c1c(OCCO)ccc2ccccc12]

8. The modified copolyester composition according to claim 1, wherein said minor amount of said aromatic diol compound ranges from 0.5 mole % to 10 mole % based on 100 mole % of a total of said C₂-C₄ aliphatic diol and said aromatic diol compound.

9. The modified copolyester composition according to claim 1, wherein a total amount of said C₂-C₄ aliphatic diol and said aromatic diol compound ranges from 1 mole to 1.5 moles based on 1 mole of said aromatic dicarboxylic acid-based component.
